(19) United States
(12) Patent Application Publication
(10) Pub. No.: US 2013/0139066 A1
(43) Pub. Date: May 30, 2013

(54) INFORMATION PROCESSING APPARATUS, INFORMATION PROCESSING METHOD, AND STORAGE MEDIUM

(71) Applicant: Canon Kabushiki Kaisha, Tokyo (JP)

(72) Inventor: Noriaki Sato, Kawasaki-shi (JP)

(73) Assignee: CANON KABUSHIKI KAISHA, Tokyo (JP)

(21) Appl. No.: 13/684,050

(22) Filed: Nov. 21, 2012

(30) Foreign Application Priority Data
Nov. 28, 2011 (JP) 2011-259152

(51) Int. Cl. G06F 3/0484

(52) U.S. Cl. CPC G06F 3/0484
USPC 715/744

(57) ABSTRACT

An information processing apparatus according to the present invention includes a first determination unit configured, if a first display region of a first display unit of the other apparatus on which the data is displayed is changed, to determine whether to receive a notification relating to the change in the first display region, a receiving unit configured to receive a notification relating to the change in the first display region according to a determination result determined by the first determination unit, and a changing unit configured to change a second display region of a second display unit of the information processing apparatus on which the data is displayed based on the notification relating to the change in the first display region received by the receiving unit.

### BACKGROUND OF THE INVENTION

1. Field of the Invention

The present invention relates to a technique capable of displaying data displayed on other apparatus by sharing the data with the other apparatus.

2. Description of the Related Art

With the development in a recent network system, a cooperative work control apparatus using a computer system has been widely employed. As one configuration of the cooperative work control apparatuses, there is provided a system configured with a combination of the following two functions.

One function is a display function. In the display function, shared data managed by a server device is transmitted to and displayed on a client device. With the display function, a user of the client device can refer to the shared data stored in the server device. Other function is a remote operation function. In the remote operation function, operation information with respect to a display region of the client device or editing information with respect to the shared data is transmitted to the server device, thereby remotely changing the shared data in the server device. With the remote operation function, a user of the client device can change the shared data stored in the server device.

Japanese Patent Application Laid-Open No. 5-46559 discusses a method which restricts an operation performed by an unauthorized client device by storing the authorization for a remote operation that has been set for each client device. Further, Japanese Patent Application Laid-Open No. 2010-33229 discusses an electronic conference system in which each client device includes a switching unit for selecting “synchronous” or “asynchronous”. Further, in the electronic conference system, when an instruction for forced synchronization is provided from one client device, the electronic conference system changes the display of other client device even if the other client device is set to be an asynchronous.

However, a client device which displays shared data that is common to other client device and a client device which displays different shared data may exist depending on the role of a user who operates the client device. In the electronic conference system, the user may play a role of a presenter, a clerk, or an observer. At this time, the shared data common to a client device used by the presenter will be displayed on a client device used by the observer. On the other hand, a client device used by the clerk may record conference minutes to a region different from the display region of the client device used by the presenter. Therefore, if the display of the client device used by the presenter is switched according to the display of the client device used by the clerk, ongoing discussion may be interrupted.

### SUMMARY OF THE INVENTION

The present invention is directed to a technique for controlling whether to change a display region in synchronization with a display region of other device.

According to an aspect of the present invention, an information processing apparatus includes a first determination unit configured, if a first display region of a first display unit of the other apparatus on which the data is displayed is changed, to determine whether to receive a notification relating to the change in the first display region, a receiving unit configured to receive a notification relating to the change in the first display region according to a determination result determined by the first determination unit, and a changing unit configured to change a second display region of a second display unit of the information processing apparatus on which the data is displayed based on the notification relating to the change in the first display region received by the receiving unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a system configuration of a cooperative work system according to an exemplary embodiment of the present invention.

FIG. 2 is a block diagram illustrating a configuration of a server device and a client device.

FIG. 3 is a flowchart illustrating cooperative work processing performed by the client device.

FIG. 4 is a flowchart illustrating notification receiving processing performed by the client device.

FIG. 5 is a table illustrating acceptance of change in each item of displayed data.

FIG. 6 is a table illustrating an example of an operation state of the client device.

FIG. 7 is a diagram illustrating a state where the client device changes the display region.

FIG. 8 is a diagram illustrating a state where the client device changes the display region.

FIG. 9 is a diagram illustrating a state where the client device changes the display region.

### DESCRIPTION OF THE EMBODIMENTS

Various exemplary embodiments, features, and aspects of the invention will be described in detail below with reference to the drawings.

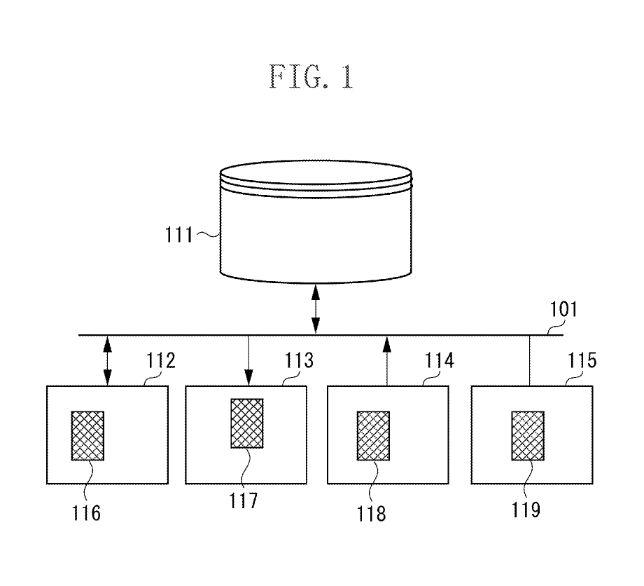

FIG. 1 is a diagram illustrating a system configuration of a cooperative work system according to an exemplary embodiment of the present invention. Incidentally, the data that is shared in the cooperative work system according to the exemplary embodiment described below is called as “shared data”.

In FIG. 1, a server device 111 plays a primary role in the cooperative work system according to the present exemplary embodiment. The server device 111 stores a cooperative work server program for realizing a management function to manage shared data and a communication function to notify the client device of change in the shared data, and can execute the program.

Client devices 112 through 115 refer to and edit the shared data managed by the server device 111. The client devices 112 through 115 store a cooperative work client program for realizing a display function to display at least a part of the shared data on each of display regions 116 through 119 and an operation function to perform operations on the shared data that is displayed on each of the display regions 116 through 119, and can execute the program.

When an operation with respect to the shared data is performed on the display region 116, the client device 112 requests the server device 111 to change the shared data via a network 101. The server device 111 receives the above request and notifies the other client devices 113 through 115 of change in the shared data via the network 101. When each of the client devices 113 through 115 receives the notification for changing the shared data from the server device 111, each of the client devices 113 through 115 updates the shared data displayed on each of the display regions 117 through 119.

The same processing is also performed when any of the other client devices 113 through 115 performs a change operation of the shared data. In this manner, the server device 111 relays the change of shared data performed by any of the client devices 112 through 115 to notify the other client of the change. Therefore, the entire client devices 112 through 115 can refer to the updated shared data. Incidentally, the client devices 112 through 115 are configured as application examples of information processing apparatuses.

As illustrated in FIG. 1, four client devices 112 through 115 are exemplified in the present exemplary embodiment. However, optional number of the client devices can be employed. Further, any one of the client devices 112 through 115 may function as the server device 111, so that this client device may execute both the cooperative work server program and the cooperative work client program simultaneously.

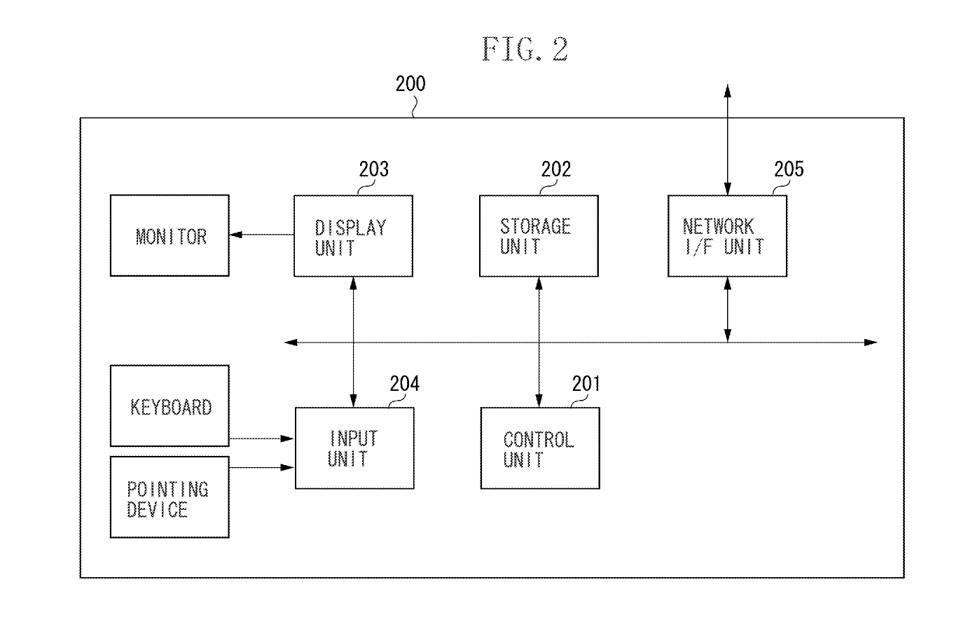

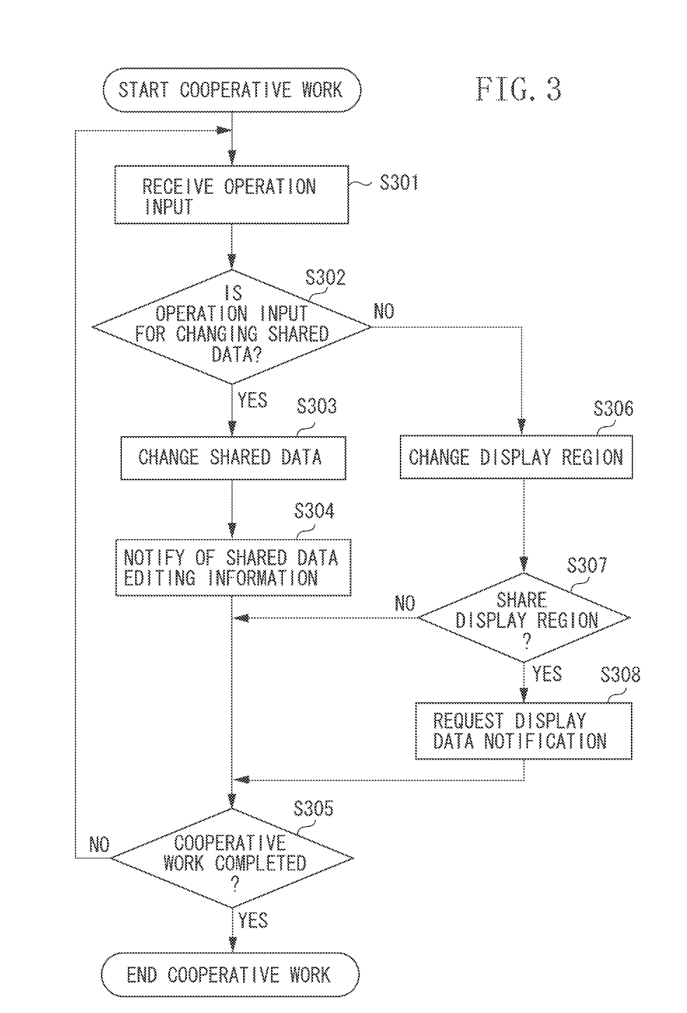

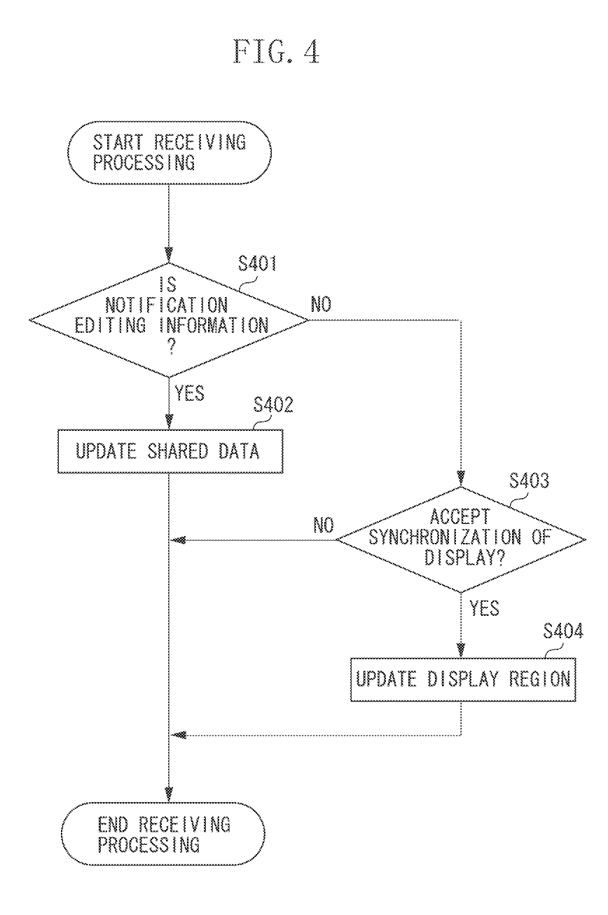

FIG. 2 is a block diagram illustrating a configuration of the server device 111 and the client devices 112 through 115. In FIG. 2, a device 200 represents any of the server device 111 and the client devices 112 through 115. A control unit 201 is configured with a central processing unit (CPU), and performs control processing for the entire device. A boot program, a basic input-output system (BIOS), various kinds of applications software, the cooperative work server program, the cooperative work client program, and data files are stored in a storage unit 202. The storage unit 202 is configured with storage media such as a read only memory (ROM), a random access memory (RAM), and a hard disk drive (HDD). For example, each of the client devices 112 through 115 performs the processing illustrated in FIGS. 3 and 4 by executing the cooperative work client program. A display unit 203 includes a built-in video memory. The control unit 201 controls the display unit 203 so that the display unit 203 performs rendering processing, and generates and outputs a display video signal. Through this, the content of the video memory is displayed on a monitor connected to the display unit 203. An input unit 204 has a function of controlling a keyboard and a pointing device serving as input devices. The input unit 204 receives operation information from the input devices such as the keyboard and the mouse connected thereto, and executes various types of processing according to the operation information. A network interface (I/F) unit 205 is configured with a network card, for example, and transmits and receives data via the network 101. The cooperative work server program and the cooperative work client program are stored in the storage unit 202, and executed by the control unit 201.

Next, with reference to FIGS. 3 and 4, a cooperative work performed by the cooperative work system according to the present exemplary embodiment, in other words, processing for displaying the shared data on the display regions 116 through 119 of the respective client devices 112 through 115, will be described. Herein, descriptions will be given by taking the client device 112 as an example. However, the same processing is performed on the other client devices 113 through 115.

FIG. 3 is a flowchart illustrating the cooperative work processing performed by the client device 112. In step S301, the client device 112 receives an operation input from a user by the input unit 204. In step S302, the client device 112 checks the location and content of the operation input and a current focus. Then, the client device 112 determines whether the operation input received in step S301 is an operation input for changing the shared data. If the client device 112 determines that the received operation input is an operation input for changing the shared data (YES in step S301), the processing proceeds to step S303. On the other hand, if the client device 112 determines that the received operation input is not an operation input for changing the shared data but for changing the display region 116 (NO in step S301), the processing proceeds to step S306.

In step S303, the client device 112 changes the shared data. In step S304, the client device 112 notifies the server device 111 of editing information which represents content of the change in the shared data. The editing information includes data and an editing command for the shared data which are input from the input unit 204, a part or all of the changed shared data, and a snapshot of a screen display. The server device 111 notifies the other client devices 113 through 115 of the notified editing information. The other client devices 113 through 115 changes the own shared data based on the notified editing information. Of course the client device 112 may directly notify the other client devices 113 through 115 of the editing information instead of notifying the other client devices through the server device 111.

In step S306, the client device 112 changes the display region 116. Each of the client devices 112 through 115 individually manages a location, a size, a zoom, a scroll position, a display page, a font size, and a font of each of the display regions 116 through 119 as display data. In step S307, the client device 112 determines whether to share the display region 116 with the other client devices 113 through 115. If the display region 116 has to be shared (YES in step S307), the processing proceeds to step S308. If the display region 116 does not have to be shared (No in step S307), the processing proceeds to step S305. Incidentally, the processing performed in step S307 is an example of the processing performed by a second determination unit.

In step S308, the client device 112 notifies the server device 111 of the display data after the change of the display region 116, and requests the server device 111 to notify the other client devices 113 through 115 of the display data. The server device 111 receives the above request, and notifies the other client devices 113 through 115 of the display data. Then, the other client devices 113 through 115 change the display regions 117 through 119 based on the notified display data respectively. Of course the client device 112 may directly notify the other client devices 113 through 115 of the display data instead of notifying the other client devices through the server device 111.

In step S305, the client device 112 determines whether completion of the cooperative work is instructed by the user. If the completion of the cooperative work is not instructed (NO in step S305), the processing returns to step S301. If the completion of the cooperative work is instructed (YES in step S305), the client device 112 ends the processing.

FIG. 4 is a flowchart illustrating notification receiving processing performed by the client device 112. In step S401, the client device 112 determines whether a received notification is editing information. If the notification is the editing information (YES in step S401), the processing proceeds to step S402. On the other hand, if the notification is not the editing information but display data (NO in step S401), the processing proceeds to step S403. In step S402, based on the editing information, the client device 112 updates the shared data displayed on the display region 116. Thereafter, the client device 112 ends the processing. In step S403, the client device 112 determines whether to accept synchronization of the display. If the client device 112 accepts the synchronization of the display (YES in step S403), the processing proceeds to step S404. On the other hand, if the client device 112 does not accept the synchronization of the display (NO in step S403), the client device 112 ends the processing. In step S404, based on the notified display data, the client device 112 changes the display region 116. The processing performed in step S403 is an example of the processing performed by a first determination unit.

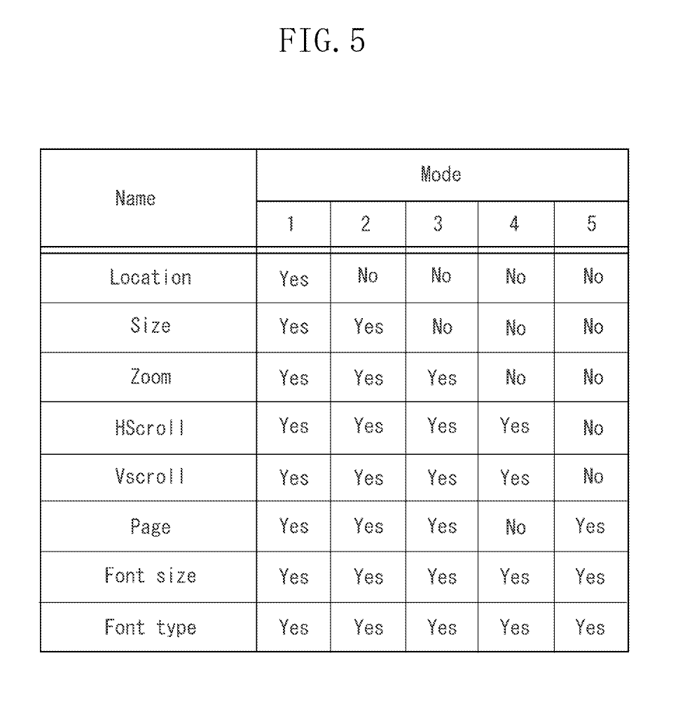

Incidentally, when the client device 112 determines whether to accept the synchronization of the display in step S403, the client device 112 may determine whether to accept the change by each item of the display data. For example, the client device 112 may accept the change in a display position of the display region 116, while not accepting the change in size of the display region 116. In this case, acceptance or rejection of the synchronization of each item of the display data (i.e., “Location”, “Size”, “Zoom”, “HScroll”, “VScroll”, “Page”, “Font Size”, and “Font”) is managed by a table as illustrated in FIG. 5. With this, the user can select the item of the display data to be synchronized according to the purpose of use. As illustrated in FIG. 5, processing for setting whether to accept the change in each item of the display data is an example of the processing performed by a third setting unit.

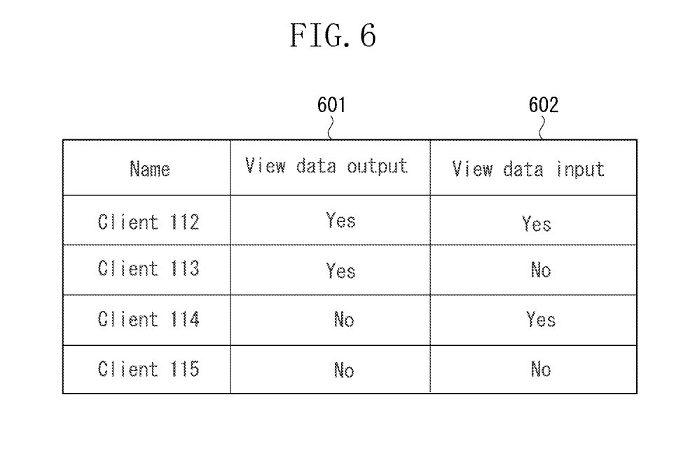

Next, how a display state of each of the display regions 116 through 119 of each of the client devices 112 through 115 changes in the cooperative work system according to the present exemplary embodiment will be described with reference to FIGS. 6 through 9.

FIG. 6 is a table illustrating examples of operation states for the client devices 112 through 115. A column 601 represents whether to execute the processing of step S308 (notification of the display data). If the column 601 is “YES”, the processing of step S308 is executed, whereas the processing thereof is not executed if the column 601 is “NO”. A column 602 represents whether to execute the processing of step S404 (change the display region). If the column 602 is “YES”, the processing of step S404 is executed, whereas the processing thereof is not executed if the column 602 is “NO”. In the example illustrated in FIG. 6, the client device 113 executes the processing of step S308, while not executing the processing of step S404. The above-described operation states may be set for the respective client devices 112 through 115 in advance, or may be switched dynamically according to an input from the input unit 204. As illustrated in FIG. 6, the processings for setting the operation states of the client devices 112 through 115 are an example of the processing performed by a first setting unit and a second setting unit.

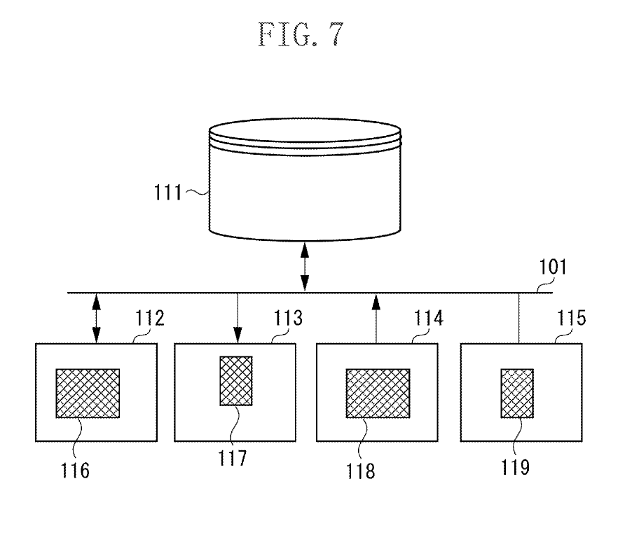

FIG. 7 is a diagram illustrating a state where the client device 112 changes the display region 116. When the client device 112 changes the display region 116 in step S306, the client device 112 notifies of the display data in step S308 as illustrated in FIG. 6. The client device 114 executes the processing in step S404 to update the display region 118, as illustrated in FIG. 6. In this case, if the client device 112 is assumed to be an application example of an information processing apparatus whereas the client device 114 is assumed to be an application example of the other device, the display region 116 is an example of a second display region of a second display unit. Further, the display region 118 is an example of a first display region of a first display unit.

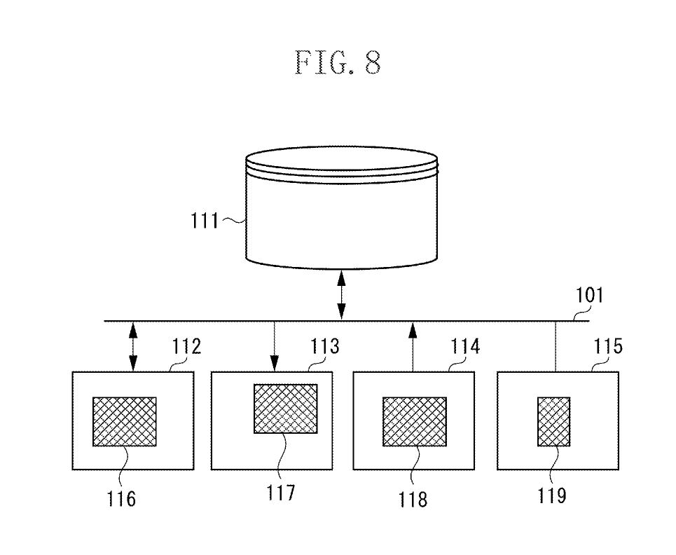

FIG. 8 is a diagram illustrating a state where the client device 113 changes the display region 117. When the client device 113 changes the display region 117 in step S306, the client device 113 notifies of the display data in step S308 as illustrated in FIG. 6. The client devices 112 and 114 execute the processing in step S404 to update the display region 116 and 118, as illustrated in the table of FIG. 6.

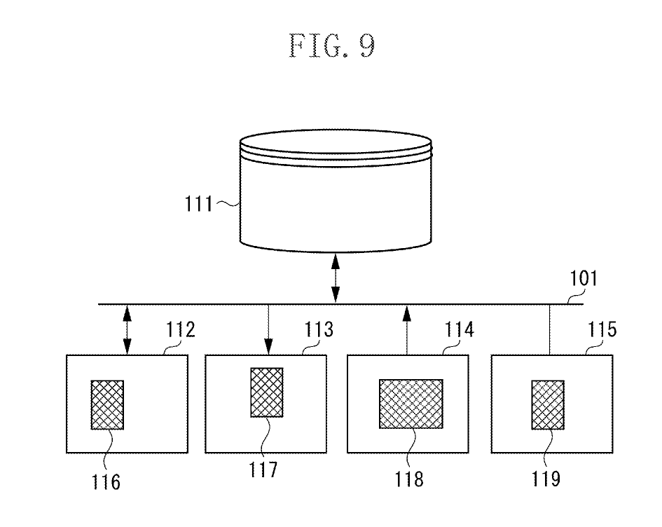

FIG. 9 is a diagram illustrating a state where the client device 114 changes the display region 118. When the client device 114 changes the display region 118 in step S306, the client device 114 does not execute the processing in step S308 (i.e., notification of the display data) as illustrated table in FIG. 6. Accordingly, none of the client devices 112, 113, and 115 executes the processing in step S404. The state illustrated in FIG. 9 is also applicable to the case where the client device 115 changes the display region 119 in step S306.

In the present exemplary embodiment, the shared data is identical in all of the client devices 112 through 115. However, the user may select whether to change the display region synchronizing with the other client devices according to the purpose of use.

While the exemplary embodiment of the present invention has been described in detail, it is to be understood that the above-described exemplary embodiment can be also realized with, for example, a system, an apparatus, a method, a program, or a recording medium (storage medium). Specifically, the above-described exemplary embodiment may be applied to a system configured with a plurality of devices (such as a host computer, an interface device, an image capturing apparatus, a web application), or an apparatus configured with a single device.

Further, the present invention can be realized by executing the following processing. In other words, the present invention can be realized in such a manner that software (a program) for realizing the functions of the above-described exemplary embodiment is supplied to a system or an apparatus via a network or various kinds of storage media, and thus a computer, a CPU, or a micro processing unit (MPU) of the system or the apparatus reads out and executes the program.

This application claims priority from Japanese Patent Application No. 2011-259152 filed Nov. 28, 2011, which is hereby incorporated by reference herein in its entirety.

What is claimed is:

1. An information processing apparatus capable of displaying data displayed on other apparatus by sharing the data with the other apparatus, the information processing apparatus comprising:
a first determination unit configured, if a first display region of a first display unit of the other apparatus on which the data is displayed is changed, to determine whether to receive a notification relating to the change in the first display region;
a receiving unit configured to receive a notification relating to the change in the first display region according to a determination result determined by the first determination unit; and
a changing unit configured to change a second display region of a second display unit of the information processing apparatus on which the data is displayed based on the notification relating to the change in the first display region received by the receiving unit.

2. The information processing apparatus according to claim 1, further comprising:
a second determination unit configured, if the second display region of the second display unit of the information processing apparatus on which the data is displayed is changed, to determine whether to transmit a notification relating to the change in the second display region; and
a transmission unit configured to transmit, according to a determination result determined by the second determination unit, a notification relating to the change in the second display region to cause the other apparatus to change the first display region based on the notification relating to the change in the second display region.

3. The information processing apparatus according to claim 1, further comprising:
a first setting unit configured to set whether to receive a notification relating to change in the first display region;
wherein the first determination unit determines whether to receive a notification relating to the change in the first display region based on content set by the first setting unit.

4. The information processing apparatus according to claim 2, further comprising:
a second setting unit configured to set whether to transmit a notification relating to change in the second display region;
wherein the second determination unit determines whether to transmit a notification relating to the change in the second display region based on content set by the second setting unit.

5. The information processing apparatus according to claim 2, further comprising:
a third setting unit configured to set whether to accept change in each item that is defined with respect to the second display region;
wherein the changing unit changes the second display region with respect to an item which is set by the third setting unit to accept the change.

6. An information processing method executed by an information processing apparatus which is capable of displaying data displayed on other apparatus by sharing the data with the other apparatus, the information processing method comprising:
determining, if a first display region of a first display unit of the other apparatus on which the data is displayed is changed, whether to receive a notification relating to the change in a first display region;
receiving a notification relating to change in the first display region according to a determination result determined by the determining; and
changing a second display region of a second display unit of the information processing apparatus on which the data is displayed, based on the notification relating to the change in the first display region received by the receiving.

7. A computer-readable storage medium storing program for causing a computer to execute an information processing method performed by an information processing apparatus capable of displaying data displayed on other apparatus by sharing the data with the other apparatus, the information processing method comprising:
determining, if a first display region of a first display unit of the other apparatus on which the data is displayed is changed, whether to receive a notification relating to the change in a first display region;
receiving the notification relating to the change in the first display region according to a determination result determined by the determining; and
changing a second display region of a second display unit of the information processing apparatus on which the data is displayed based on the notification relating to the change in the first display region received by the receiving.
